(19) United States
(12) Patent Application Publication
(10) Pub. No.: US 2010/0169813 A1
(43) Pub. Date: Jul. 1, 2010

(54) METHOD FOR DISPLAYING AND OPERATING USER INTERFACE AND ELECTRONIC DEVICE

(75) Inventor: Ching-Chih Chang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/402,492

(22) Filed: Mar. 11, 2009

(30) Foreign Application Priority Data
Dec. 25, 2008 (TW) 97150767

(51) Int. Cl. G06F 3/048

(52) U.S. Cl. 715/767; 715/844; 715/841; 715/835

(57) ABSTRACT

A method for displaying and operating a user interface and an electronic device are provided. In the method, a background frame is displayed. Further, a trigger signal triggered by an object on one of a plurality of areas of the background frame is received, in which the areas respectively correspond to a plurality of sub-menus of a function menu, and each of the sub-menus includes a plurality of options. The corresponding sub-menu is displayed on the area of the background frame which the trigger signal is triggered on. Thereby, usage convenience of the user interface is improved.

### CROSS-REFERENCE TO RELATED APPLICATION

This application claims the priority benefit of Taiwan application serial no. 97150767, filed on Dec. 25, 2008. The entirety of the above-mentioned patent application is hereby incorporated by reference herein and made a part of specification.

### BACKGROUND OF THE INVENTION

1. Field of the Invention

The present invention relates to a user interface, and particularly to a method for displaying and operating the user interface.

2. Description of Related Art

As technology advances, various sorts of electronic devices are continually developed, for example notebook computers, personal digital assistants (PDA) and cell phones. In order to enhance usage convenience of the electronic devices, prior art applies touch screens to the electronic devices. The touch screen can not only be used to display frames, but can also be used to operate the electronic device, so they are a kind of convenient tool.

In detail, when the touch screen is used as an input device, a user may directly press the touch screen through a stylus or a finger. The touch screen generates a corresponding trigger signal in an area of aforesaid pressing. At this moment the electronic device may execute corresponding functions, such as movement of a cursor or selection of an object according to the trigger signals.

Compared with a conventional method of using a keyboard and a mouse, the touch screen allows the user to operate more easily, and the user can learn how to use the touch screen in a short time. Hence, by being equipped with the touch screen, the electronic device can obtain favor of people with high convenience. What should be noted is that the touch screen must cooperate with a suitable user interface to fully elaborate the convenience thereof. Hence, many manufactures are devoted to developing user interfaces with higher convenience. The following introduces the user interface of the electronic device of the prior art.

FIGS. 1A and 1B are schematic views showing the conventional electronic device and the user interface thereof. Referring to FIGS. 1A and 1B, an electronic device 10 includes a touch screen 11 and buttons 12 to 15. The user may control the electronic device 10 through the touch screen 11 or the buttons 12 to 15. In a standby mode, the touch screen 11 only displays a menu 20, and the menu 20 is displayed on a lower left corner of the touch screen 11. A shape thereof is a fan shape. When the user presses a position of the menu 20 displayed on the touch screen 11, sub-menus 21 to 26 are displayed on an edge of the menu 20 and extend inside the touch screen 11. More specifically, the sub-menus 21 to 26 are adjacent to each other, and surround the menu 20 in a circular manner.

However, in the standby mode, although the menu 20 may inform the user of the position to press, the menu 20 still takes up a frame displayed on the touch screen, thereby obstructing the user from operating the user interface currently displayed on the touch screen. In order to make the frame displayed by the touch screen 11 to seem more succinct, the prior art especially limited the menu 20 and the sub-menus 21 to 26 to the lower left corner of the touch screen 11. However, such a method generates another drawback. All areas of the touch screen 11 cannot be effectively used, and the sub-menus 21 to 26 cannot clearly display menu contents due to a small area.

### SUMMARY OF THE INVENTION

The present invention provides a method for displaying and operating a user interface which enhance usage convenience of the user interface.

The present invention provides an electronic device which displays a corresponding sub-menu on an area of a background frame according to an area on which a trigger signal is present, thereby summoning the sub-menu more quickly. The method for displaying and operating the user interface provided by the present invention includes displaying the background frame. In addition, a first trigger signal triggered by a first object on one of a plurality of areas of the background frame is received. Moreover, according to the area on which the first trigger signal is present, the corresponding sub-menu is displayed on the area of the background frame, wherein the aforesaid plurality of areas respectively corresponds to a plurality of sub-menus of a function menu, and each of the sub-menus includes a plurality of options.

According to an embodiment of the present invention, after a step of displaying the corresponding sub-menu on the area of the background frame according to the area on which the first trigger signal is present, the method for displaying and operating the user interface further includes checking whether the first object moves to another area of the background frame. When the first object moves to the other area of the background frame, another sub-menu corresponding to the other area is switched to be displayed on the other area of the background frame.

According to an embodiment of the present invention, after a step of displaying the corresponding sub-menu on the area of the background frame according to the area on which the first trigger signal is present, the method for displaying and operating the user interface further includes receiving a second trigger signal triggered by a second object on another area of the background frame. In addition, another sub-menu corresponding to the other area is switched to be displayed on the other area of the background frame.

According to an embodiment of the present invention, after the step of displaying the corresponding sub-menu on the area of the background frame according to the area on which the first trigger signal is present, the method for displaying and operating the user interface further includes receiving the second trigger signal triggered by the second object on the option of the displayed sub-menu. Moreover, corresponding operating functions are executed according to the option on which the second trigger signal is present. According to another embodiment, the aforesaid operating functions include displaying one of a next layer of menu of the option and starting one of option functions of the option.

According to an embodiment of the present invention, after the step of displaying the background frame, the method for displaying and operating the user interface further includes displaying a system panel on the background frame of the user interface, wherein the system panel includes a plurality of system icons.

According to an embodiment of the present invention, after the step of displaying the corresponding sub-menu on the area of the background frame according to the area on which the first trigger signal is present, the method for displaying and operating the user interface further includes receiving a third trigger signal triggered by a third object on the system icon of the system panel of the background frame. Moreover, the displayed sub-menu is hidden behind the background frame.

According to an embodiment of the present invention, after the step of displaying the corresponding sub-menu on the area of the background frame according to the area on which the first trigger signal is present, the method for displaying and operating the user interface further includes adding up an idle time in which the displayed sub-menu is idle. When the idle time exceeds a predetermined time, the displayed sub-menu is hidden behind the background frame.

According to an embodiment of the present invention, the sub-menu includes being displayed in a half transparent or non-transparent state on the area of the background frame.

According to an embodiment of the present invention, after the step of displaying the background frame, the method for displaying and operating the user interface further includes displaying a system information on the background frame of the user interface. According to another embodiment, the system information includes a time, an unanswered call, a new mail, a signal strength of a wireless communication or a calendar.

According to an embodiment of the present invention, the step of displaying the background frame includes switching among a plurality of images in a display storage unit as the background frame.

From another point of view, the present invention provides an electronic device for using the aforesaid method for displaying and operating the user interface provided by the present invention. The electronic device displays the corresponding sub-menu on the area of the background frame according to the area on which the trigger signal is present, so as to enhance usage convenience of the user interface.

According to the area on which the trigger signal is present, the present invention displays the corresponding sub-menu on the same area of the background frame, thereby allowing the user to quickly summon the sub-menu. When the trigger signal moves or jumps to another area, the sub-menu presently displayed is switched to the sub-menu corresponding to the other area, so as to quickly switch among the sub-menus. In addition, when another trigger signal is received on one of the options of the sub-menu, the operating function corresponding to the option may be executed or the next level of menu corresponding to the option may be displayed. Hence, usage convenience of the user interface may be enhanced.

To make the aforesaid features and advantages of the present invention more comprehensible, several embodiments accompanied with figures are illustrated in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A and 1B are schematic views showing a conventional touch screen and a user interface thereof.

FIG. 2 is a flowchart showing a method for displaying and operating a user interface according to the first embodiment of the present invention.

FIGS. 3A to 3C are schematic views showing a user interface according to the first embodiment of the present invention.

FIG. 4 is a flowchart showing a method for displaying and operating a user interface according to the second embodiment of the present invention.

FIGS. 5A to 5F are schematic views showing a user interface according to the second embodiment of the present invention.

FIG. 6 is a block diagram showing an electronic device according to the third embodiment of the present invention.

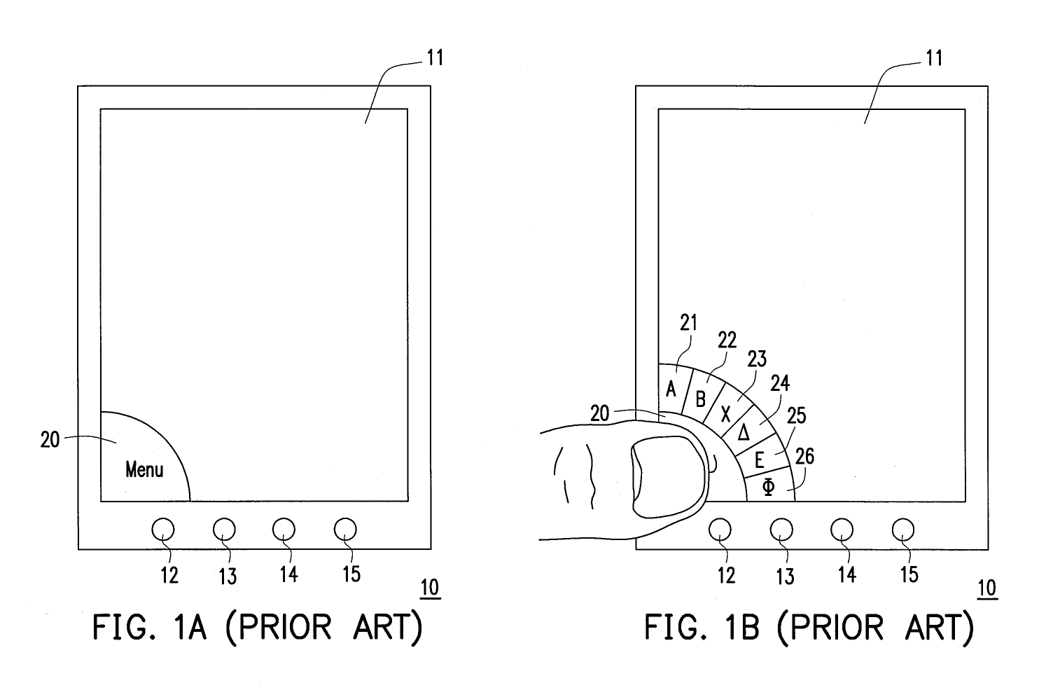

### DESCRIPTION OF EMBODIMENTS

The present invention aims at a user interface of an electronic device, and a set of operating methods used to summon menus of the user interface or to switch among the different menus is designed. In order not to affect normal operations of the user interface, the present invention hides the menus behind a background frame of the electronic device, and disposes corresponding positions of each of the menus on a touch screen according to a number of the menus. When a user touches the touch screen or selects the user interface, the electronic device may display the corresponding menu at a touching position, so that the user only needs a single touch motion to summon the menus desired to be operated and switch among them. In order to make the present invention more comprehensible, embodiments are described below as examples to demonstrate that the present invention can actually be realized.

### First Embodiment

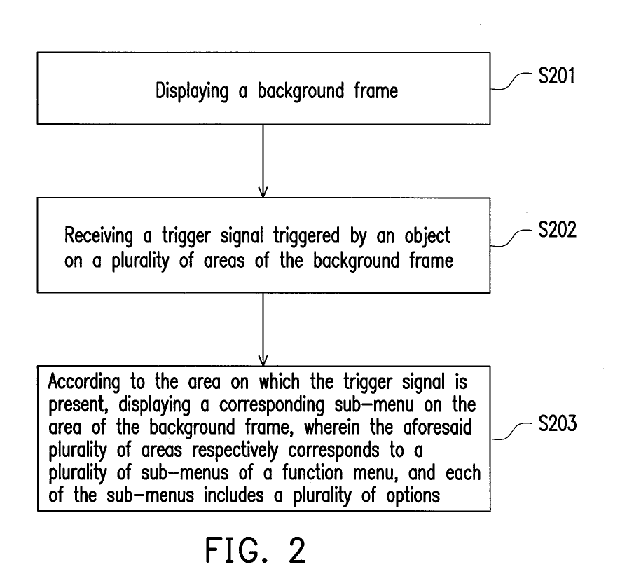

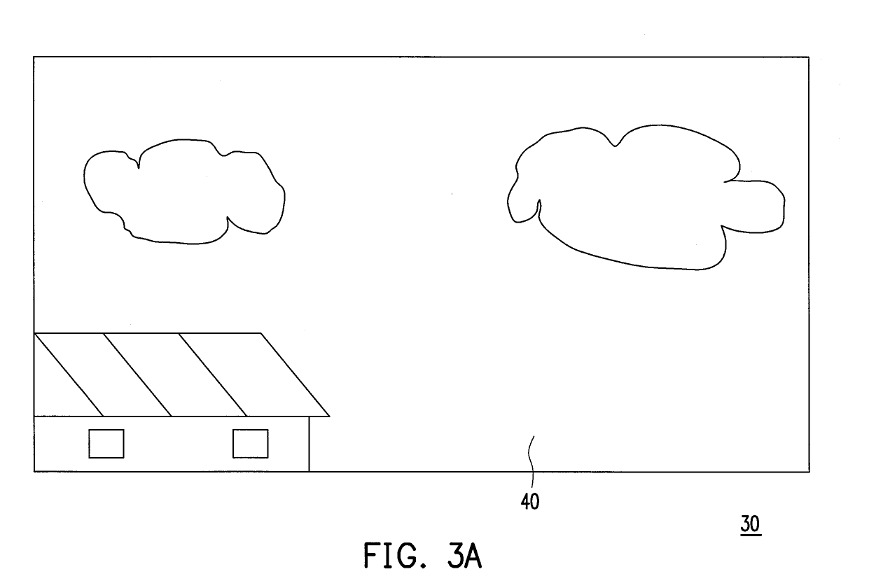

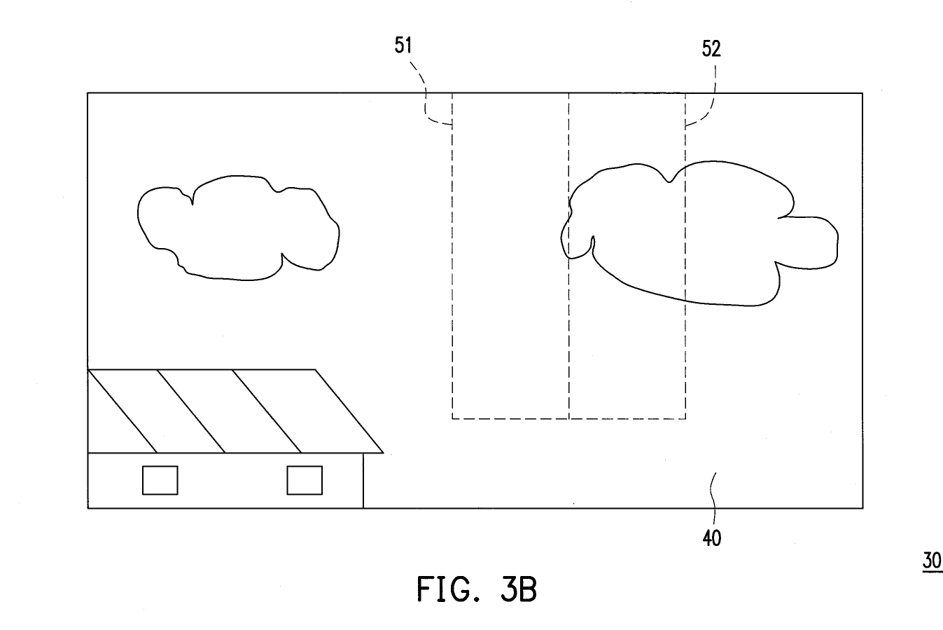

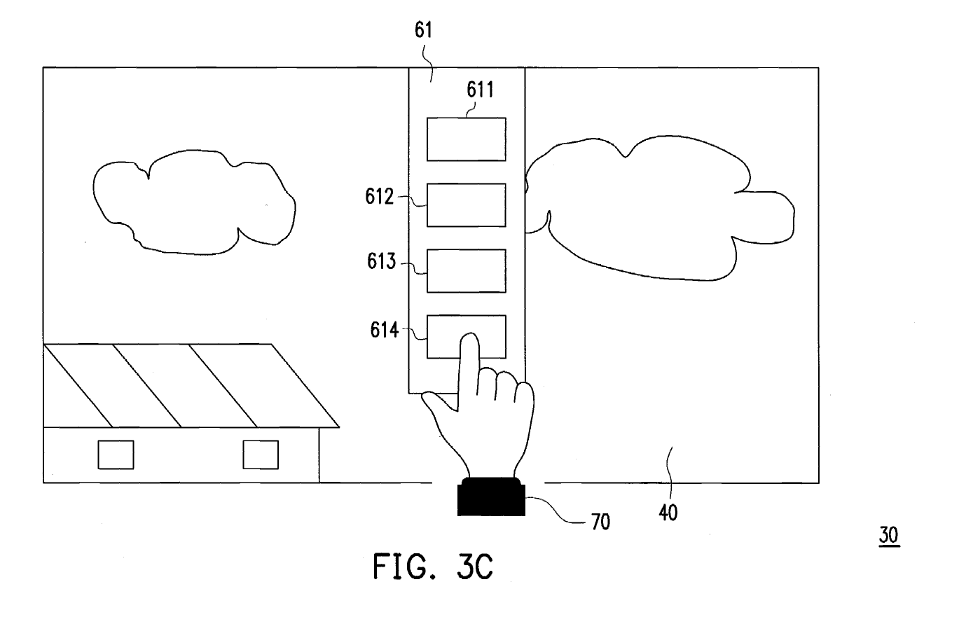

FIG. 2 is a flowchart showing a method for displaying and operating a user interface according to the first embodiment of the present invention. FIGS. 3A to 3C are schematic views showing a user interface according to the first embodiment of the present invention. Referring to all FIGS. 2 and 3A to 3C, first the background frame may be displayed on the user interface (a step S201). For example, clouds and houses may be displayed on a background frame 40 (as shown in FIG. 3A), but the present invention is not limited herein. According to other embodiments, persons having ordinary skills in the art may chose to display different background frames according to requirements thereof.

It should be noted that, the background frame may be divided into a plurality of areas, which respectively corresponds to a plurality of sub-menus of a function menu, and each of the sub-menus may include a plurality of options. For example, the aforesaid areas are areas 51 and 52 (as shown in FIG. 3B), and the aforesaid sub-menus may be a sub-menu 61 (as shown in FIG. 3C) and another sub-menu (not shown). More specifically, the area 51 corresponds to the sub-menu 61. The area 52 corresponds to the other sub-menu. Moreover, the sub-menu 61 includes options 611 to 614. Please note that when the electronic device displays the background frame, the areas divided in the background frame are not displayed, so that the user's observing the background frame is not affected. In addition, the aforesaid area may be distributed in any positions on the background frame, so as to effectively use each of the positions on the background frame to display the corresponding menus.

Under normal circumstances, the user interface does not display the sub-menus on the background frame, so as to maintain beauty and succinctness of the user interface. When the user interface receives a trigger signal triggered by an object on one of the areas of the background frame (a step S202), according to the area on which the trigger signal is present, the user interface displays the corresponding sub-menu on the same area of the background frame (a step S203).

For example, when a user 70 touches the touch screen on the area 51 (as shown in FIG. 3B), a user interface 30 generates the trigger signal and uses it to display the sub-menu 61 and the options 611 to 614. In other words, if the user 70 desires to summon the sub-menu 61, the user 70 only needs to touch the area 51 corresponding to the sub-menu 61, so as to easily and quickly summon the sub-menu 61. Hence, usage convenience of the user interface 30 may be enhanced.

It should be noted that the above trigger signal is generated by an input device. The present embodiment uses the touch screen as an example, and the user may press the touch screen to generate the corresponding trigger signal, but the present invention is not limited herein. According to other embodiment, the trigger signal may be the users controlling a cursor on a screen to move to the corresponding area through a mouse, and pressing a button of the mouse to generate the corresponding trigger signal.

According to the present embodiment, a number of the plurality of areas and the plurality of sub-menus corresponding thereto are set as two for an example, but the present invention is not limited herein. According to other embodiments, persons having ordinary skills in the art may design different numbers of a plurality of areas and a plurality of sub-menus corresponding thereto according to requirements thereof.

It must be noted that, although the above embodiment has illustrated a possible type of the method for displaying and operating the user interface, it is common sense to persons having ordinary skills in the art that different manufacturers design different steps for the method for displaying and operating the user interface, and applications of the present invention should not be limited to only the possible type. In other words, if according to the area on which the trigger signal is present, the corresponding sub-menu is displayed on the same area of the background frame, the spirit of the present invention is complied to. The following further provides some other embodiments to allow persons having ordinary skills in the art to recognize the spirit of the present invention and implement the present invention.

### Second Embodiment

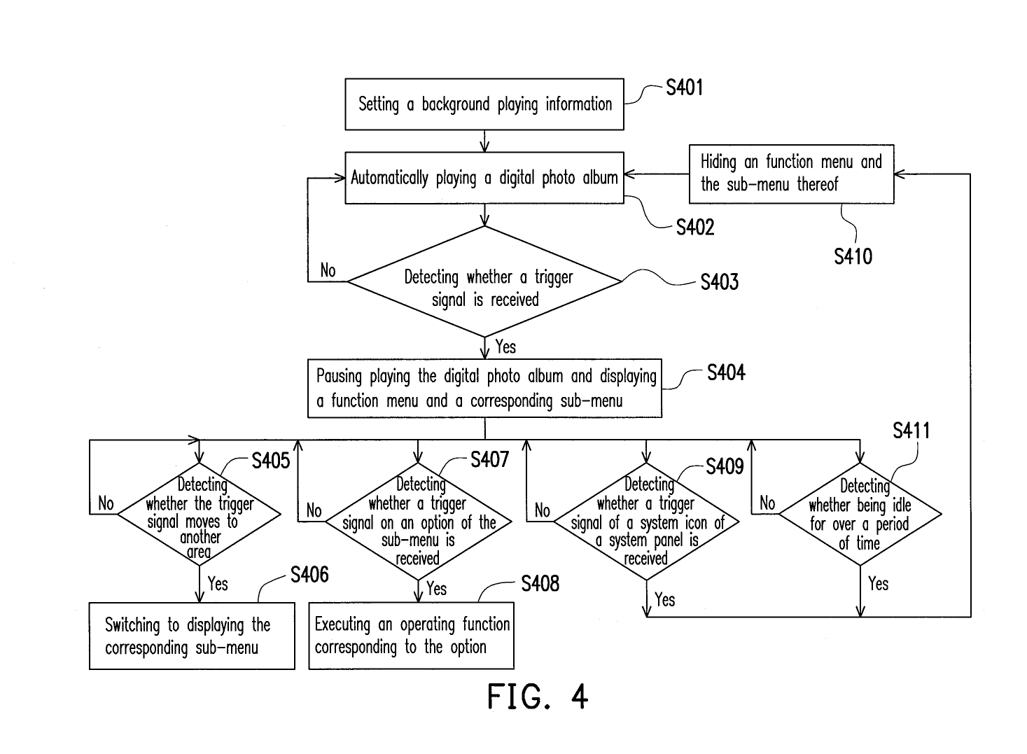

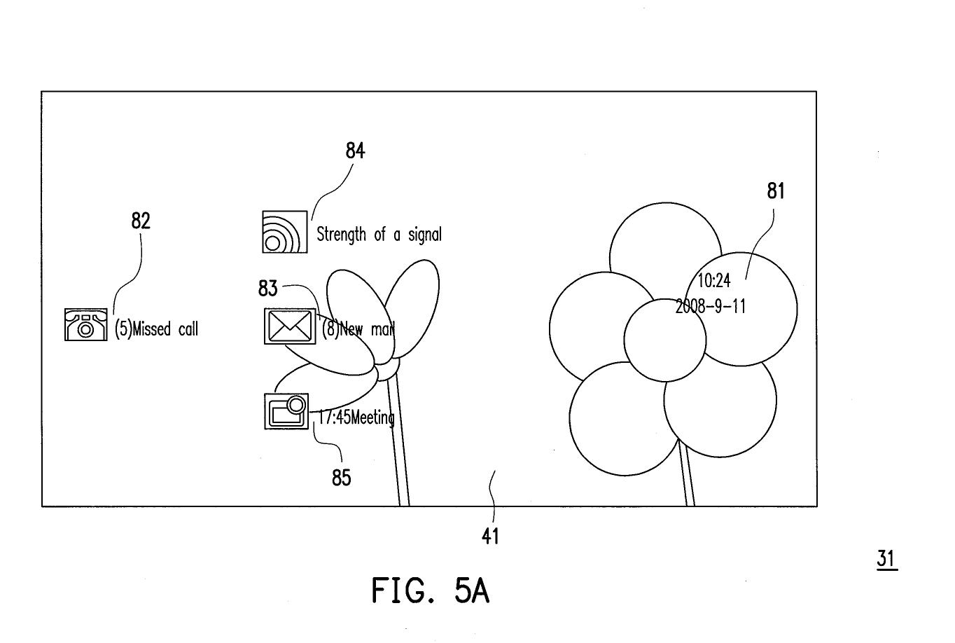

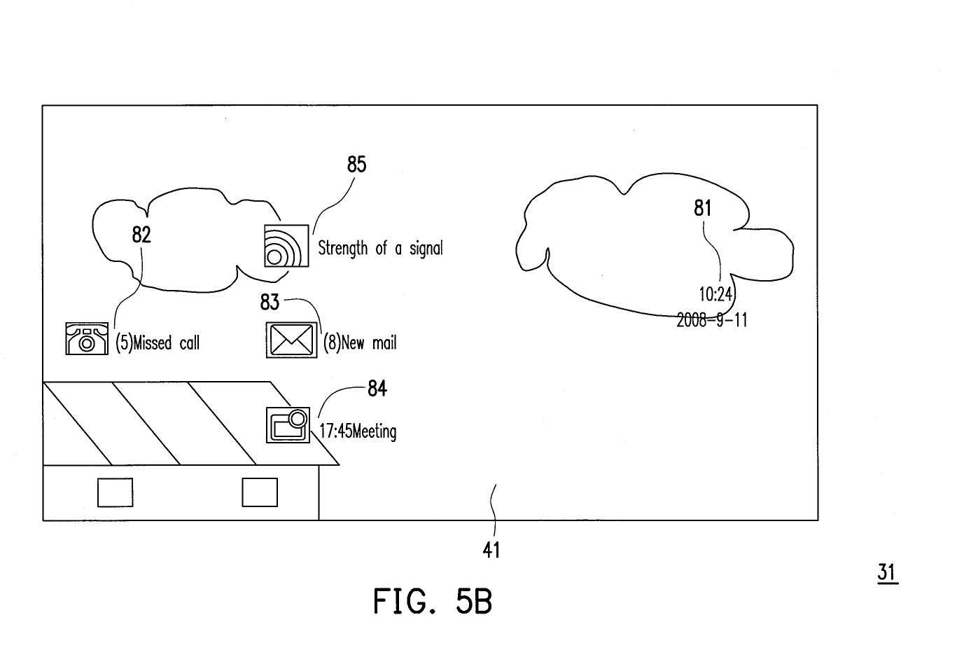

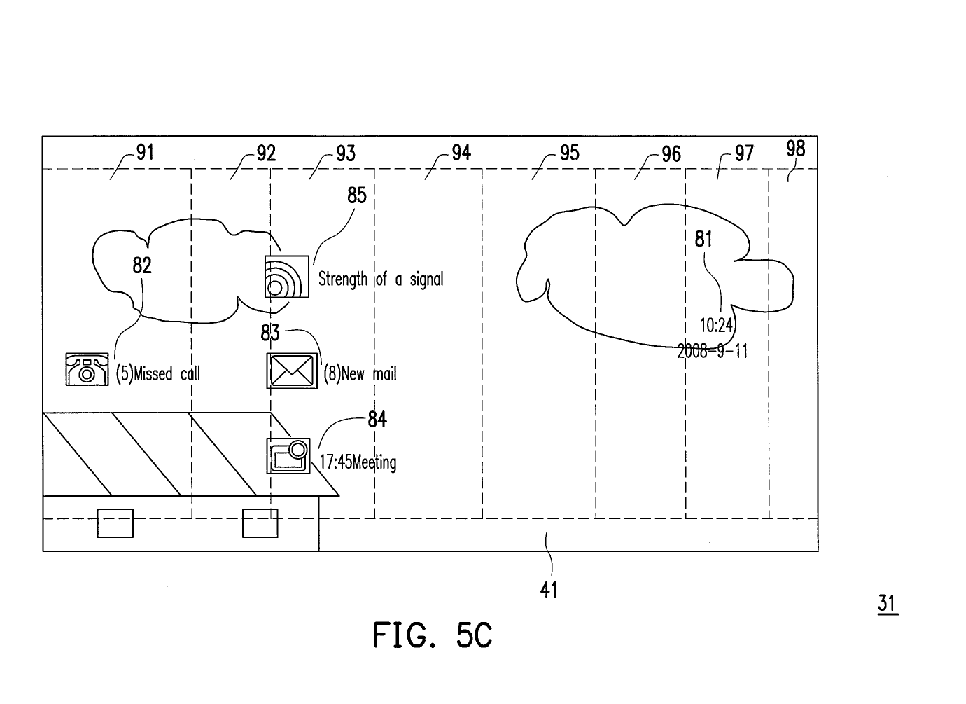

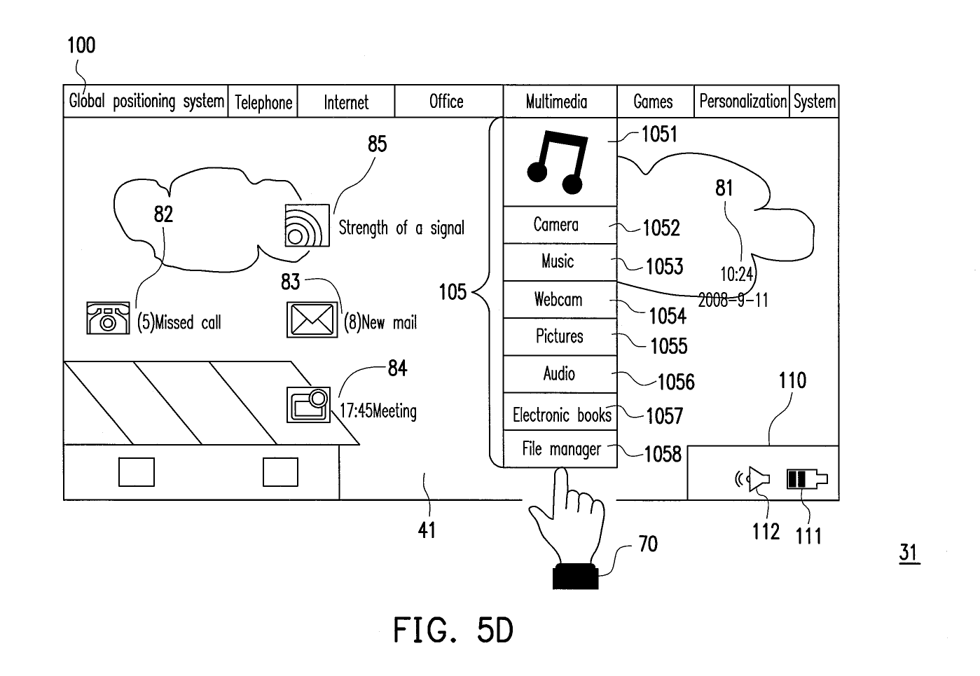

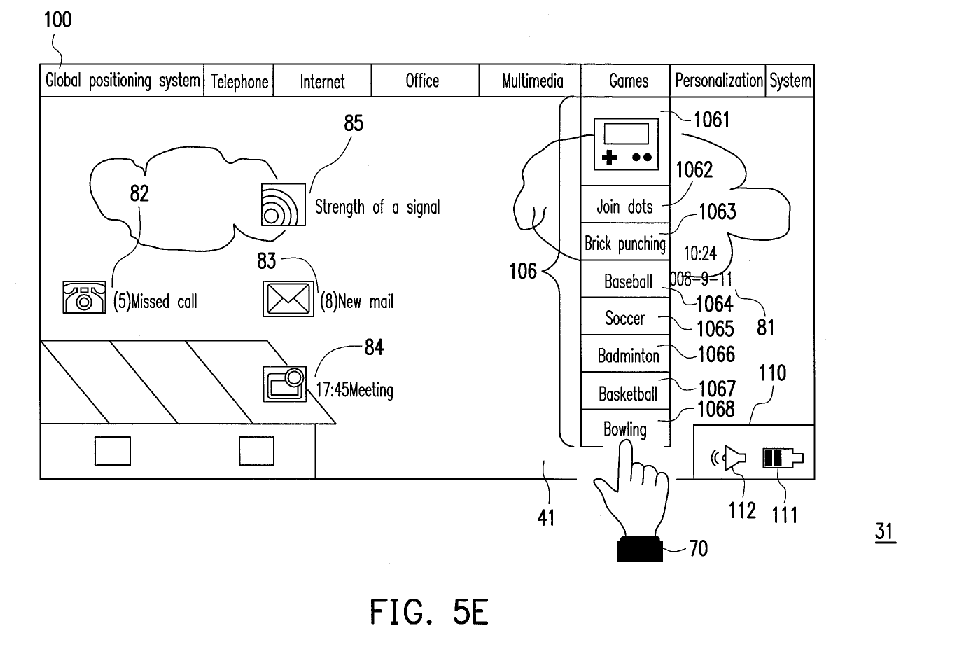

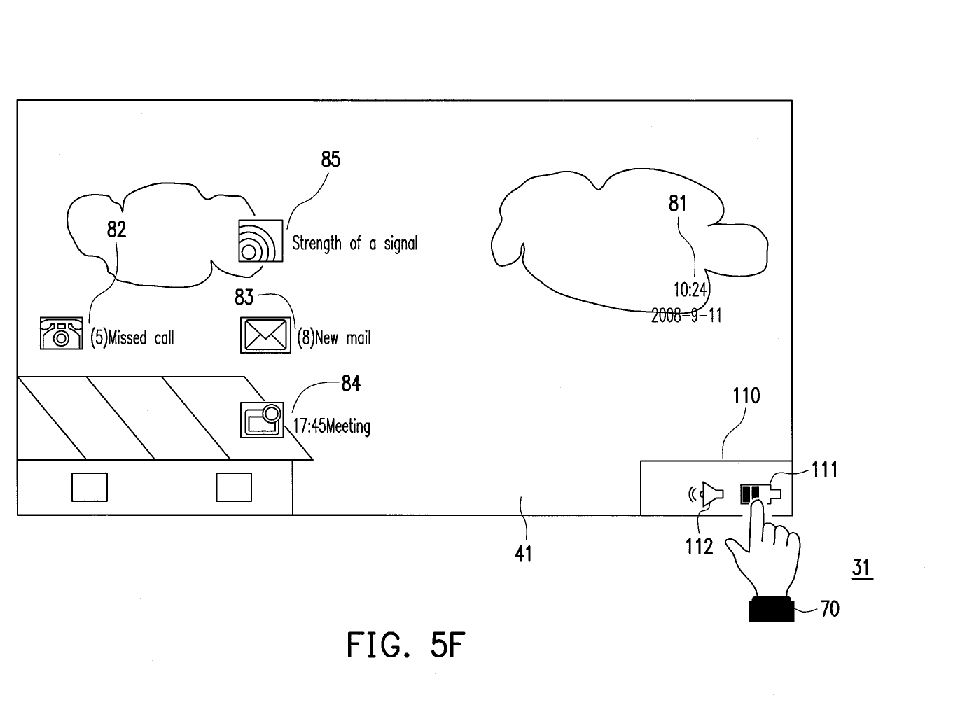

FIG. 4 is a flowchart showing a method for displaying and operating a user interface according to the second embodiment of the present invention. FIGS. 5A to 5F are schematic views showing a user interface according to the second embodiment of the present invention. Referring to all FIGS. 4 and 5A to 5F, first a background playing information may be set (a step S401). For example, a background frame 41 may be set to be displayed on a user interface 31. For example, a predetermined picture may be selected form a plurality of pictures to be an initial background frame 41. In addition, whether to enable a function of a digital photo album may be set, so as to change the background frame 41. Moreover, a playing mode of the digital photo album may be set. For example, one of the plurality of pictures may be randomly selected to be played, or one of the plurality of pictures may be selected to be played according to a sequence of names of the pictures.

Furthermore, a system information may be set to be displayed on the background frame of the user interface. For example, referring to FIG. 5A, the system information may include a time 81, an unanswered call 82, a new mail 83, a strength of a signal 84 and a calendar 85. The time 81 may be used to display the present time. The unanswered call 82 may be used to remind the user 70 of unanswered calls. The new mail 83 may be used to remind the user 70 that there is new mail provided to be read. The strength of the signal 84 is used to display a strength of a signal of reception of the electronic device. The calendar 85 may remind the user 70 of upcoming agendas. According to other embodiments, the system information may include other information.

After completing setting the aforesaid background playing information, the electronic device automatically plays the digital photo album (a step S402). More specifically, the user interface according to the present embodiment supports the digital photo album, and after a function of the digital photo album is enabled, after each period of time, for example 5 seconds, the user interface switches among the pictures to be used as the background frame. For example, if the initial background frame 41 of the user interface 31 is flowers (as shown in FIG. 5A), after 5 seconds, the user interface 31 replaces the background frame 41 from the flowers to clouds and houses (as shown in FIG. 5B).

It should be noted that, the background frame 41 may be divided to a plurality of areas, for example areas 91 to 98 (as shown in FIG. 5C). The areas 91 to 98 respectively correspond to one of the sub-menus of a function menu 100. For example, the area 95 corresponds to the sub-menu 105 (as shown in FIG. 5D), and the area 96 corresponds to the sub-menu 106 (as shown in FIG. 5E). The sub-menu 105 includes, for example, options 1051 to 1058. The sub-menu 106 includes, for example, options 1061 to 1068.

Next, the electronic device may detect whether the trigger signal is received (a step S403). If yes, a step S404 is then performed; if no, the step S402 is returned to. According to the present embodiment, when the user touches any of the areas of the background frame, the trigger signal is generated. For example, when the user 70 touches the area 95 of the background frame 41, the trigger signal corresponding to the area 95 is generated.

When the electronic device detects the trigger signal, for example, it pauses a playing function of the digital photo album and displays the function menu and the corresponding sub-menu on the background frame (the step S404). For example, when the electronic device detects the trigger signals, the background frame 41 freezes and is not switched as time passes, thereby avoiding switching of the background frame interfering with operation of the function menu 100 by the user 70. Moreover, the user interface 31 also displays the menu 100 and the sub-menu 105 corresponding to the area 95 (as shown in FIG. 5D), including displaying options 1051 to 1058 of the sub-menu 105. In addition, the user interface 31 may also display a system panel 110 on the background frame 41 (as shown in FIG. 5D). The system panel 110 may include a plurality of system icons, for example system icons 111 and 112.

Next, the user interface may detect whether the received trigger signal moves to another area (the step S405), so as to switch to displaying the sub-menu corresponding to the area (a step S406). For example, when the user 70 touches the area 95 and drags to the area 96, meaning that the trigger signal moves from the area 95 to the area 96, the user interface 31 also switches to the sub-menu 106 corresponding to the area 96 (as shown in FIG. 5E). Please note that according to other embodiments, by detecting the trigger signal generated on another area, the electronic device may also switch the currently displayed sub-menu to the sub-menu corresponding to the area.

On the other hand, the user interface may detect whether the trigger signal triggered on one of the options of the sub-menu is received (a step S407), so as to execute an operating function corresponding to the option (a step S408). For example, if the user 70 touches the option 1058 of the sub-menu 105, the user interface 31 may execute an option function corresponding to the option 1058, which is opening a file manager. Similarly, as the user 70 touches different options, the user interface 31 executes other corresponding operating functions, for example opening the next level of menu corresponding to the option.

Accordingly, the user interface may detect whether the trigger signal triggered on the system icon of the system panel is received (a step S409), so as to thereby hide an displayed function menu and the sub-menu behind the background frame (a step S410). For example, if the user touches the system icon 111 of the system panel 110, the trigger signal is generated. At this moment, the user interface 31 hides a function menu 100 and the sub-menu thereof behind the background frame 41 (as shown in FIG. 5F).

In addition, the user interface may add up an idle time in which the displayed sub-menu is idle (a step S408), and when the idle time exceeds a predetermined time, the displayed function menu and the sub-menu are also hidden behind the background frame (the step S410). The predetermined time is, for example, 1 minute, but is not limited herein.

According to the present embodiment, although the user touches the user interface to generate the trigger signal, it is only a kind of optional embodiment. According to other embodiments, the trigger signal may also be generated by controlling a cursor with a mouse to select the user interface, thereby operating the user interface.

### Third Embodiment

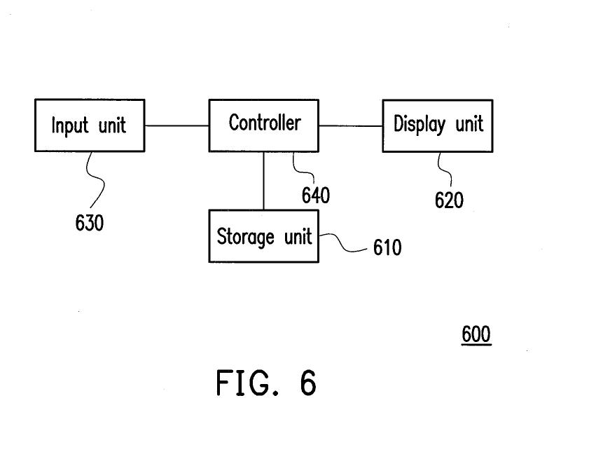

FIG. 6 is a block diagram showing an electronic device according to the third embodiment of the present invention. Referring to FIG. 6, an electronic device 600 is, for example, a notebook computer, a PDA, a cellular phone or a multimedia player which includes a storage unit 610, a display unit 620, an input unit 630 and a controller 640. The controller 640 is respectively coupled to the storage unit 610, the display unit 620 and the input unit 630. The following introduces functions of each of components in the electronic device 600.

The storage unit 610 is, for example, a hard drive or a memory which may be used to store data, pictures or files. The display unit 620 is, for example, a monitor which is used to display a frame. The input unit 630 is, for example, a trackpad which is disposed on the display unit 620 and used for the user to operate the electronic device 600. In other words, the input unit 630 and the display unit 620 may be combined into the touch screen, but the present invention is not limited herein. According to other embodiments, the input unit 630 may also be a keyboard, a mouse or a button. The controller 640 may be used to control operations of the electronic device 600.

It should be noted that, the method for displaying and operating the user interface illustrated according to the aforesaid embodiments may be applied to the electronic device 600. For example, the controller 640 controls the display unit 620 to display the background frame according to the pictures stored in the storage unit 610. In addition, the controller may receive the trigger signal triggered by the input unit 630 on one of the plurality of areas on the background frame, and controls the display unit 620 to display the corresponding sub-menu on the area of the background frame according to the area on which the trigger signal is present. Each of the areas respectively corresponds to each of the sub-menus of the function menu, and each of the sub-menus includes a plurality of options.

According to an embodiment, the controller 640 may check whether the trigger signal moves to another area of the background frame. When the trigger signals moves to the other area of the background frame, the controller 640 may control the display unit 620 to switch to displaying another sub-menu corresponding to the other area on the other area of the background frame. In addition, the controller 640 may also receive another trigger signal triggered by the input unit on another area of the background frame, so as to control the display unit 620 to switch to displaying another sub-menu corresponding to the other area on the other area of the background frame.

According to another embodiment, the controller 640 may receive the trigger signal triggered on one of the options of the displayed sub-menu, and executes the corresponding operating function according to the options on which the trigger signal is present. The operating function is, for example, the next level of menu of the option displayed by the display unit 620 being controlled by the controller 640 or starting a function of the option.

According to an embodiment, the controller may control the display unit 620 to display the system panel on the background frame of the user interface, wherein the system panel includes a plurality of system icons. When the controller 640 receives the trigger signal triggered by the input unit 630 on one of the system icons of the system panel of the background frame, the controller 640 may control the display unit 620 to hide the displayed sub-menu behind the background frame.

According to an embodiment, the controller 640 further adds up the idle time in which the sub-menu displayed by the display unit 620 is idle, and when the idle time exceed the predetermined time, the controller 640 controls the display unit 620 to hide the displayed sub-menu behind the background frame. The above sub-menu includes being displayed on the area of the background frame in a half transparent or non-transparent state.

According to an embodiment, the controller 640 may control the display unit 620 to display the system information on the background frame of the user interface. The aforesaid system information includes the time, the unanswer calls, the new mail, the signal strength of the wireless communication or the calendar. Moreover, the controller 640 may control the display unit 620 to switch among displaying the plurality of pictures of the digital photo album as the background frame.

In summary, according to the area on which the trigger signal is present, the present invention displays the corresponding sub-menu on the same area of the background frame, thereby allowing the user to quickly summon the sub-menu desired to be operated. Additionally, according to movement of the trigger signal or triggering of another trigger signal, displaying the corresponding sub-menu is switched to, so as to allow the user to quickly switch among the sub-menus. When the options of the sub-menu are selected, the corresponding functions may be executed, thereby enhancing usage convenience of the user interface.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method for displaying and operating a user interface, comprising:
displaying a background frame;
receiving a first trigger signal triggered by a first object on one of a plurality of areas of the background frame; and
displaying a corresponding sub-menu on the area of the background frame, according to the area on which the first trigger signal is present, wherein the plurality of areas respectively correspond to the plurality of sub-menus of a function menu, and each of the sub-menus comprises a plurality of options.

2. The method for displaying and operating the user interface of claim 1, after the step of displaying the corresponding sub-menu on the area of the background frame according to the area on which the first trigger signal is present, further comprising:
checking whether the first object moves to another area of the background frame; and
when the first object moves to the other area of the background frame, switching to display another sub-menu corresponding to the other area on the other area of the background frame.

3. The method for displaying and operating the user interface of claim 1, after the step of displaying the corresponding sub-menu on the area of the background frame according to the area on which the first trigger signal is present, further comprising:
receiving a second trigger signal triggered by a second object on another area of the background frame; and
switching to display another sub-menu corresponding to the other area on the other area of the background frame.

4. The method for displaying and operating the user interface of claim 1, after the step of displaying the corresponding sub-menu on the area of the background frame according to the area on which the first trigger signal is present, further comprising:
receiving a second trigger signal triggered by a second object on one of the options of the displayed sub-menu; and
executing a corresponding operating function according to the option on which the second trigger signal is present.

5. The method for displaying and operating the user interface of claim 4, wherein the operating function comprises one of displaying a next layer of menu of the option and starting an option function of the option.

6. The method for displaying and operating the user interface of claim 1, after the step of displaying the background frame, further comprising:
displaying a system panel on the background frame of the user interface, wherein the system panel comprises a plurality of system icons.

7. The method for displaying and operating the user interface of claim 6, after the step of displaying the corresponding sub-menu on the area of the background frame according to the area on which the first trigger signal is present, further comprising:
receiving a third trigger signal triggered by a third object on one of the plurality of system icons of the system panel of the background frame; and
hiding the displayed sub-menu behind the background frame.

8. The method for displaying and operating the user interface of claim 1, after the step of displaying the corresponding sub-menu on the area of the background frame according to the area on which the first trigger signal is present, further comprising:
adding up an idle time in which the displayed sub-menu is idle; and
when the idle time exceeds a predetermined time, hiding the displayed sub-menu behind the background frame.

9. The method for displaying and operating the user interface of claim 1, wherein the sub-menu comprises being displayed in a half transparent or non-transparent state on the area of the background frame.

10. The method for displaying and operating the user interface of claim 1, after the step of displaying the background frame, further comprising:
displaying a system information on the background frame of the user interface.

11. The method for displaying and operating the user interface of claim 10, wherein the system information comprises a time, an unanswered call, a new mail, a signal strength of a wireless communication or a calendar.

12. The method for displaying and operating the user interface of claim 1, wherein the step of displaying the background frame, further comprises:
switching among displaying a plurality of pictures in a storage unit to be used as the background frame.

13. An electronic device, comprising:
a storage unit, for storing at least a picture;
a display unit;
an input unit; and
a controller, coupled to the storage unit, the display unit and the input unit, for controlling the picture to be displayed on the display unit as a background frame, receiving a first trigger signal generated by the input unit being triggered by a first object on one of a plurality of areas of the background frame, and according to the area on which the first trigger signal is present, controlling the display unit to display a corresponding sub-menu on the area of the background frame, wherein the plurality of areas respectively corresponds to the plurality of sub-menus of a function menu, and each of the sub-menus comprises a plurality of options.

14. The electronic device of claim 13, wherein the controller further checks whether the first object moves to another area of the background frame, and when the first object moves to the other area of the background frame, controlling the display unit to switch to displaying another sub-menu corresponding to the other area on the other area of the background frame.

15. The electronic device of claim 13, wherein the controller further receives a second trigger signal generated by the input unit being triggered by a second object on another area of the background frame, and controls the display unit to switch to displaying another corresponding sub-menu corresponding to the other area on the other area of the background frame.

16. The electronic device of claim 13, wherein the controller further receives a second trigger signal generated by being trigger by a second object on one of the plurality of options of the displayed sub-menu, and executes a corresponding operating function according to the option on which the second trigger signal is present.

17. The electronic device of claim 16, wherein the operating function includes one of displaying a next layer of menu of the option and starting an option function of the option.

18. The electronic device of claim 13, wherein the controller further controls the display unit to display a system panel on the background frame of the user interface, and the system panel comprises a plurality of system icons.

19. The electronic device of claim 18, wherein the controller further receives a third trigger signal generated by the input unit being triggered by a third object on one of the plurality of system icons of the system panel of the background frame, and controls the display unit to hide the displayed sub-menu behind the background panel.

20. The electronic device of claim 13, wherein the controller further adds up an idle time in which the sub-menu displayed by the display unit is idle, and when the idle time exceeds a predetermined time, controlling the display unit to hide the displayed sub-menu behind the background frame.

21. The electronic device of claim 13, wherein the sub-menu comprises being displayed in a half transparent or non-transparent state on the area of the background frame.

22. The electronic device of claim 13, wherein the controller further controls the display unit to display a system information on the background frame of the user interface.

23. The electronic device of claim 22, wherein the system information comprises a time, an unanswered call, a new mail, a signal strength of a wireless communication and a calendar.

24. The electronic device of claim 13, wherein the controller further controls the display unit to switch among displaying a plurality of pictures in the storage unit to be used as the background frame.

25. The electronic device of claim 13, wherein the input unit and the display unit are combined into a touch panel.
